(19) United States
(12) Patent Application Publication
(10) Pub. No.: US 2010/0119667 A1
(43) Pub. Date: May 13, 2010

(54) READY-TO-DRINK ALCOHOLIC BEVERAGE

(76) Inventor: Anthony Livaich, McKinney, TX (US)

Correspondence Address: CANTOR COLBURN, LLP, 20 Church Street, 22nd Floor, Hartford, CT, 06103, US

(21) Appl. No.: 12/487,752

(22) Filed: Jun. 19, 2009

Related U.S. Application Data
(60) Provisional application No. 61/113,923, filed on Nov. 12, 2008.
(60) Provisional application No. 61/142,458, filed on Jan. 5, 2009.

(51) Int. Cl. A23L 1/185; A23L 1/236; B65D 85/72; C12H 1/18

(52) U.S. Cl. 426/131; 426/592; 426/548

(57) ABSTRACT

A ready-to-drink beverage has an alcohol content of about 5 to about 9 percent by volume, at least 90% of which is provided by a malt-based alcoholic composition. The malt-based alcoholic composition has little or no hop flavor, as quantified by a Hop Aroma Component Profile value less than or equal to 0.05 microliter per liter.

### CROSS REFERENCE TO RELATED APPLICATIONS

This application claims priority to U.S. Provisional Application Ser. No. 61/113923 filed on Nov. 12, 2008, and U.S. Provisional Application Ser. No. 61/142458, filed on Jan. 5, 2009, the entire contents of which are hereby incorporated by reference.

### BACKGROUND OF THE INVENTION

Mankind has been preparing and consuming alcoholic beverages for thousands of years. See, e.g., Anonymous, “Social and Cultural Aspects of Drinking”, The Social Issues Research Centre, 1998, page 8, available at http://www.sirc.org/publik/social_drinking.pdf (“Alcohol has played a central role in almost all human cultures since Neolithic times (about 4000 BC).”). Alcoholic beverages can take many forms, including beer and ale, wine, spirits, and mixed drinks, including cocktails.

One popular segment of ready-to-drink cocktails is so-called flavored malt beverages. This segment includes such liquor-branded beverages as Smirnoff Ice, Captain Morgan Gold, Stolichnaya Citrona, Sauza Diablo, SKYY Blue, Jack Daniel's Original Hard Cola, Bacardi Silver, and Cruzan Jumble Brew. (The segment excludes products labeled as flavored beer, such as raspberry-flavored beers, and coffee-flavored porters.) Under current United States law, up to 49% of the total alcohol content of a flavored malt beverage can be derived from alcohol sources other than the fermentation of barley malt. 27 C.F.R. §7.11(a)(1). One such alternative alcohol source is so-called citric acid blender, which is ethanol to which a large amount (e.g., 11% by weight) of citric acid has been added to render the alcohol unfit for direct human consumption. Citric acid blender has been used in the formulation of flavored malt beverages because it can be cost effective as a partial alcohol source, and its citric acid component can provide a desired astringency to many beverages. However, the use of citric acid blender poses handling and storage challenges. Specifically, it is highly flammable, so its use often requires a segregated storage facility and specialized mixing equipment. There is therefore a need for flavored malt beverages that reduce or eliminate the use of citric acid blender.

### BRIEF DESCRIPTION OF THE INVENTION

The above-described drawbacks are alleviated by a ready-to-drink beverage, comprising: a malt-based alcoholic composition in an amount effective to provide an alcohol content of about 5 to about 9 percent by volume, based on the total volume of the ready-to-drink beverage; wherein malt-based alcoholic composition has a Hop Aroma Component Profile value less than or equal to 0.05 microliter per liter; and wherein at least 90% of the alcohol content of the ready-to-drink beverage is derived from the malt-based alcoholic composition.

This and other embodiments are described in detail below.

### DETAILED DESCRIPTION OF THE INVENTION

The present inventor has conducted research on flavored malt beverages, and in particular malt-based ready-to-drink cocktails. (As used herein, the term “ready-to-drink” means that the beverage is ready to be consumed with addition of any further ingredients. Ready-to-drink beverages are distinguished from, for example, beverage concentrates, which are not directly consumed but are instead diluted with water to form a ready-to-drink beverage.) The present inventor has determined that it is possible for formulate such beverages while using little or no alcohol from sources other than the malt-based alcoholic composition, provided that the malt-based alcoholic composition has a neutral flavor objectively quantified by a Hop Aroma Component Profile value less than or equal to 0.05 microliter per liter. The malt-based ready-to-drink cocktails are organoleptically pleasing. And, particularly when the malt-based ready-to-drink cocktails are unsweetened tomato-based cocktails, such as a Bloody Mary, some consumers prefer them to corresponding cocktails formulated with spirits rather than a malt-based alcoholic composition.

One embodiment is a ready-to-drink beverage, comprising: a malt-based alcoholic composition in an amount effective to provide an alcohol content of about 5 to about 9 percent by volume, based on the total volume of the ready-to-drink beverage; wherein malt-based alcoholic composition has a Hop Aroma Component Profile value less than or equal to 0.05 microliter per liter; and wherein at least 90% of the alcohol content of the ready-to-drink beverage is derived from the malt-based alcoholic composition.

The ready-to-drink beverage comprises a malt-based alcoholic composition that is substantially free of hops flavor. As used herein, the term “malt-based alcoholic composition” refers to an alcoholic composition derived from fermentation of an infusion or decoction, or combination of both, in potable brewing water, of malted barley with hops, or their parts or products, and with or without other malted cereals, and with or without the addition of unmalted or prepared cereals, other carbohydrates or products prepared therefrom. Hops flavor, which is often present in malt-based fermentation products, is particularly undesirable in a cocktail traditionally based on vodka or another neutral spirit. The substantial absence of hops flavor can be objectively quantified according to the Hop Aroma Component Profile. Briefly, Hop Aroma Component Profile (HACP) is a measurement of the sum of twenty-two compounds known to contribute to the “hoppy” aroma of beer. HACP values have been shown to be correlated with the extent of hop taste in beer, as determined by sensory evaluation. The definition and measurement of Hop Aroma Component Profile is described in G. Nickerson and E. L. Van Engel, “Hop Aroma Component Profile and the Aroma Unit”, Journal of the American Society of Brewing Chemists, 1992, volume 50, pages 77-81; and E. L. Van Engel and G. Nickerson, “Use of the Hop Aroma Component Profile to Calculate Hop Rates for Standardizing Aroma Units and Bitterness Units in Brewing”, Journal of the American Society of Brewing Chemists, 1992, volume 50, pages 82-88. The substantial absence of hops flavor corresponds to a Hop Aroma Component Profile value less than or equal to 0.05 microliter per liter. In some embodiments, the Hop Aroma Component Profile is less than or equal to 0.03 microliter per liter, specifically less than or equal to 0.01 microliter per liter.

Methods of preparing malt-based alcoholic compositions free of hops flavor are known in the art and include, for example, those described in U.S. Pat. No. 2,803,546 to Bergmann et al., U.S. Pat. No. 3,908,021 to Rehberger et al., and U.S. Pat. No. 7,008,652 B2 to Effler, all three of which are hereby incorporated by reference.

The malt-based alcoholic composition is used in an amount effective to provide an alcohol content of about 5 to about 9 percent by volume, specifically about 6 to about 8 percent by volume, based on the total volume of the ready-to-drink beverage. The malt-based alcoholic composition itself can have an alcohol content of about 7 to about 16 percent by volume, specifically about 9 to about 15 percent by volume, more specifically about 12 to about 15 percent by volume, based on the total volume of the malt-based alcoholic composition. The amount of the malt-based alcoholic composition can also be expressed as a weight percent of the total weight of the ready-to-drink beverage. Specifically, the ready-to-drink beverage can comprise about 35 to about 65 weight percent of the malt-based alcoholic composition, based on the total weight of the ready-to-drink beverage. Within this range, the amount of the malt-based alcoholic composition can be about 40 to about 60 weight percent, specifically about 45 to about 55 weight percent.

The ready-to-drink beverage derives at least 90% of its alcohol content from the malt-based alcoholic composition. It is possible to derive at least 93%, at least 95%, at least 97%, or even 100% of the alcohol content from the malt-based alcoholic composition. However, it is often convenient to include in the ready-to-drink beverage at least some flavor components that contain some alcohol. Thus, the amount of alcohol derived from the malt-based alcoholic composition can be 90 to about 98%, specifically about 93 to about 97%.

One aspect of avoiding substantial concentrations of citric acid blender is that the ready-to-drink beverage can be formulated with any desired citric acid concentration. Specifically, the ready-to-drink beverage can comprise less than or equal to 0.9 weight percent citric acid, based on the total weight of the ready-to-drink beverage. Given that a small amount of citric acid may be desirable to produce astringency, in some embodiments the citric acid concentration is about 0.3 to 0.9 weight percent, specifically about 0.4 to about 0.7 weight percent, more specifically about 0.5 to about 0.6 weight percent. It will be understood that “weight percent citric acid” is the sum of the weight percent of free citric acid and the weight percents of any citrate salts, each expressed as the equivalent weight of free citric acid. For example, a beverage containing 0.25 weight percent citric acid and 0.25 weight percent sodium citrate dihydrate would have 0.415 weight percent citric acid.

The ready-to-drink beverage can be sweetened or unsweetened. When the beverage is sweetened, it can include a bulk sweetener, a high-intensity sweetener, or a mixture thereof. Bulk sweeteners include, for example, sucrose, dextrose, maltose, dextrin, xylose, ribose, glucose, mannose, galactose, fructose (levulose), lactose, invert sugar, fructooligosaccharide syrups, partially hydrolyzed starch, corn syrup solids, high fructose corn syrup, sorbitol, xylitol, mannitol, galactitol, maltitol, hydrogenated isomaltulose, lactitol, erythritol, hydrogenated starch hydrolysates, and combinations thereof. Bulk sweeteners further include sugar alcohols (also known as polyols), including glycerol, sorbitol, xylitol, mannitol, galactitol, maltitol, hydrogenated isomaltulose (isomalt), lactitol, erythritol, hydrogenated starch hydrolysate, polyglycitol (e.g., syrup or powder), and combinations thereof. In general, an effective amount of bulk sweetener will depend on the sweetener type and the ready-to-drink beverage type. Suitable amounts for each type of sweetener can be selected by one of ordinary skill in the art without undue experimentation. In some embodiments, the amount of bulk sweetener is about 10 to about 25 weight percent, specifically about 11 to about 24 weight percent, more specifically about 12 to about 24 weight percent, even more specifically about 18 to about 24 weight percent. When a bulk-sweetened but reduced calorie beverage is desired, the amount of bulk sweetener can be about 8 to about 15 weight percent, specifically about 10 to about 14 weight percent.

High-intensity sweeteners include, for example, saccharin, saccharin salts, cyclamate salts, sodium and potassium and ammonium and calcium salts of 3,4-dihydro-6-methyl-1,2,3-oxathiazine-4-one-2,2-dioxide, L-aspartyl-L-phenylalanine methyl ester, L-alpha-aspartyl-N-(2,2,4,4-tetramethyl-3-thietanyl)-D-alaninamide hydrate, N-[N-(3,3-dimethylbutyl)-L-aspartyl]-L-phenylalanine 1-methyl ester, methyl esters of L-aspartyl-L-phenylglycerine and L-aspartyl-L-2,5-dihydrophenyl-glycine, L-aspartyl-2,5-dihydro-L-phenylalanine, L-aspartyl-L-(1-cyclohexen)-alanine, 1-chloro-1′-deoxysucrose, 4-chloro-4-deoxy-alpha-D-galactopyranosyl-alpha-D-fructofuranoside, 4-chloro-4-deoxygalactosucrose, 4-chloro-4-deoxy-alpha-D-galactopyranosyl-1-chloro-1-deoxy-beta-D-fructo -furanoside, 4,1′-dichloro-4,1′-dideoxygalactosucrose, 1′,6′-dichloro-1′,6′-dideoxysucrose, 4-chloro-4-deoxy-alpha-D-galactopyranosyl-1,6-dichloro-1,6-dideoxy-beta-D-fructofuranoside, 4,1′,6′-trichloro-4,1′,6′-trideoxygalactosucrose, 4,6-dichloro-4,6-dideoxy-alpha-D-galactopyranosyl-6-chloro-6-deoxy-beta-D-fructofuranoside, 4,6,6′-trichloro-4,6,6′-trideoxygalactosucrose, 6,1′,6′-trichloro-6,1′,6′-trideoxysucrose, 4,6-dichloro-4,6-dideoxy-alpha-D-galacto-pyranosyl-1,6-dichloro-1,6-dideoxy-beta-D-fructofuranoside, 4,6,1′,6′-tetrachloro4,6,1′,6′-tetradeoxygalacto-sucrose, 4,6,1′,6′-tetradeoxy-sucrose, thaumaoccous danielli (Thaumatin I and II), monatin, rebaudiosides (including rebaudioside A), lo han guo (lo han quo), and combinations thereof. The amount of the high-intensity sweetener, when present, can be about 0.001 to about 1 weight percent, specifically about 0.01 to about 0.3 weight percent, based on the total weight of the ready-to-drink beverage.

The ready-to-drink beverage can include added water. As used herein “added water” does not include water incidentally added to the composition through other components such as, for example, the malt-based alcoholic composition, high fructose corn syrup, or a fruit juice component. When present, the added water can be used in an amount of about 1 to about 60 weight percent, specifically about 10 to about 55 weight percent, more specifically about 25 to about 50 weight percent, based on the total weight of the ready-to-drink beverage.

The ready-to-drink beverage can include flavors. Suitable flavors include apple flavors, apricot flavors, aromatic bitters flavors, banana flavors, berry flavors (including blackberry flavors, blueberry flavors, celery flavors, cherry flavors, coffee flavors, cranberry flavors, strawberry flavors, raspberry flavors, and juniper berry flavors), brandy flavors, cachaca flavors, carrot flavors, cherry flavors, chocolate flavors, cinnamon flavors, citrus flavors (including lemon flavors, lime flavors, orange flavors, grapefruit flavors, and tangerine flavors), coconut flavors, cola flavors, cooling agents (e.g., menthol), gin flavors, ginger flavors, licorice flavors, hot flavors (e.g., Heat), milk flavors, mint flavors, nut flavors (including almond flavors, hazelnut flavors, macadamia nut flavors, peanut flavors, pecan flavors, pistachio flavors, and walnut flavors), peach flavors, pear flavors, pepper flavors, pineapple flavors, plum flavors, quinine flavors, rum flavors (including white rum flavors and dark rum flavors), sangria flavors, shellfish flavors (including clam flavors), tea flavors (including black tea flavors and green tea flavors), tequila flavors, tomato flavors, top note flavors, tropical flavors, vanilla flavors, vermouth flavors (including dry vermouth flavors and sweet vermouth flavors), whiskey flavors (including bourbon whiskey flavors, Irish whiskey flavors, rye whiskey flavors, Scotch whisky flavors, and Canadian whiskey flavors), and combinations thereof. The flavoring agents can be used in liquid or solid/dried form and can be used individually or in admixture. When employed in dried form, suitable drying means such as spray drying an oil can be used. Alternatively, the flavoring agent is absorbed onto water-soluble materials, such as cellulose, starch, sugar, maltodextrin, gum arabic and so forth or can be encapsulated. In still other embodiments, the flavoring agent is adsorbed onto silicas, zeolites, and the like. The techniques for preparing such dried forms are well-known.

Suitable amounts of flavors can be selected by one of ordinary skill in the art without undue experimentation. In some embodiments, the flavors can be present in the ready-to-drink beverage in an amount of about 0.1 to about 8 weight percent based on the total weight of the ready-to-drink beverage. Within this range, the amount of flavors can be about 0.2 to about 5 weight percent, specifically about 0.3 to about 2 weight percent.

The ready-to-drink beverage can, optionally, further include a flavor potentiator. Flavor potentiators are materials that can intensify, supplement, modify or enhance the taste and/or aroma perception of a composition without introducing a characteristic taste and/or aroma perception of their own. In some embodiments, potentiators designed to intensity, supplement, modify, or enhance the perception of flavor, sweetness, tartness, umami, kokumi, saltiness, and combinations thereof.

Examples of flavor potentiators, also known as taste potentiators, include neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), sugar acids, potassium chloride, sodium acid sulfate, hydrolyzed vegetable proteins, hydrolyzed animal proteins, yeast extracts, adenosine monophosphate (AMP), glutathione, nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt), sugar beet extract (alcoholic extract), sugarcane leaf essence (alcoholic extract), curculin, strogin, mabinlin, gymnemic acid, hydroxybenzoic acids, 3-hydrobenzoic acid, 2,4-dihydrobenzoic acid, citrus aurantium, vanilla oleoresin, sugarcane leaf essence, maltol, ethyl maltol, vanillin, licorice glycyrrhizinates, compounds that respond to G-protein coupled receptors (T2Rs and T1Rs), G-protein coupled receptors (T2Rs and T1Rs), and taste potentiator compositions that impart kokumi, as disclosed in U.S. Pat. No. 5,679,397 to Kuroda et al., herein incorporated by reference, and combinations thereof. “Kokumi” refers to materials that impart “mouthfulness” and “good body”.

Sweetener potentiators, which are a type of flavor potentiator, enhance the taste of sweetness. In some embodiments, exemplary sweetener potentiators include, mono ammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, hydroxybenzoic acids, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), G-protein coupled receptors (T2Rs and T1Rs), hydroxybenzoic acid amides as disclosed in WO 2006/024587 to Ley et al., hydroxydeoxybenzoins (hydroxyl-substituted 1,2-diphenylethanones) as disclosed in WO2006/106023 to Ley et al., and combinations thereof.

Additional examples of potentiators for the enhancement of salt taste include acidic peptides, such as those disclosed in U.S. Pat. No. 6,974,597, herein incorporated by reference. Acidic peptides include peptides having a larger number of acidic amino acids, such as aspartic acid and glutamic acid, than basic amino acids, such as lysine, arginine and histidine. The acidic peptides are obtained by peptide synthesis or by subjecting proteins to hydrolysis using endopeptidase, and if necessary, to deamidation. Suitable proteins for use in the production of the acidic peptides or the peptides obtained by subjecting a protein to hydrolysis and deamidation include plant proteins, (e.g. wheat gluten, corn protein (e.g., zein and gluten meal), soybean protein isolate), animal proteins (e.g., milk proteins such as milk casein and milk whey protein, muscle proteins such as meat protein and fish meat protein, egg white protein and collagen), and microbial proteins (e.g., microbial cell protein and polypeptides produced by microorganisms).

The ready-to-drink beverage can, optionally, further include additives such as antioxidants, amino acids, caffeine, coloring agents (“colorants”, “colorings”), emulsifiers, flavor potentiators, food-grade acids, minerals, micronutrients, plant extracts, phytochemicals (“phytonutrients”), preservatives, salts including buffering salts, stabilizers, thickening agents, medicaments, vitamins, and combinations thereof. Those of ordinary skill in the art will appreciate that certain additives may meet the definition or function according to more than one of the above-listed additive categories.

Suitable salts for use in the ready-to-drink beverage include, alkali or alkaline earth metal chlorides, glutamates, and the like. Examples include monosodium glutamate, potassium chloride, sodium chloride, and combinations thereof. The salts can be added to the beverage as a flavor potentiator as previously described.

In addition to citric acid, as mentioned above, other suitable food-grade acids for use in the ready-to-drink beverage include, acetic acid, adipic acid, ascorbic acid, butyric acid, formic acid, fumaric acid, glyconic acid, lactic acid, malic acid, phosphoric acid, oxalic acid, succinic acid, tartaric acid, and combinations thereof. The food-grade acid can be added as acidulant to control the pH of the beverage, to provide some preservative properties, or to stabilize the beverage.

The pH of the ready-to-drink beverage can also be modified by the addition of food-grade base compounds such as sodium hydroxide, ammonium hydroxide, sodium carbonate, potassium carbonate, sodium bicarbonate, alkali metal salts of the food-grade acids mentioned above, and the like, and combinations thereof. Additionally, the pH of the ready-to-drink beverage can be adjusted by the addition of carbon dioxide. In some embodiments, the ready-to-drink beverage is mildly acidic, exhibiting a pH value of about 2.5 to about 5 specifically about 2.5 to about 4.5, more specifically about 3 to about 4. In some embodiments, the pH is about 2.5 to about 3.5. The pH value is measured at 20° C. on an unpressurized sample of the ready-to-drink beverage. For example, if the ready-to-drink beverage is a carbonated beverage, the pH is measured on a sample of the beverage before carbonation or after allowing the carbonated beverage to equilibrate with one atmosphere of air at 20° C.

In some embodiments, the tartness of the composition may be varied by selecting and combining acids to provide a desired tartness perception. Some factors to consider in determining a desired tartness include, for example, the acid's dissociation constant, solubility, pH, etc. These variables can be measured by measuring the titratable acidity of the beverage composition. Tartness can also be measures by standard sensory science techniques such as those described by H. Moskowitz in “Sourness of Acid Mixtures” as published in The Journal of Experimental Psychology, April 1974; 102(4); 640-7 and in “Ratio Scales of Acid Sourness” as published in Perception and Psychophysics; 9:371-374, 1971.

Coloring agents can be used in amounts effective to produce a desired color for the composition. The colorants may include pigments, natural food colors and dyes suitable for food, drug and cosmetic applications. A full recitation of all F.D.& C. colorants and their corresponding chemical structures can be found in the Kirk-Othmer Encyclopedia of Chemical Technology, 3rd Edition, in volume 5 at pages 857-884.

As classified by the United States Food, Drug, and Cosmetic Act (21 C.F.R. 73), colors can include exempt from certification colors (sometimes referred to as natural even though they can be synthetically manufactured) and certified colors (sometimes referred to as artificial), and combinations thereof. In some embodiments, exemplary exempt from certification or natural colors can include, annatto extract, (E160b), bixin, norbixin, astaxanthin, dehydrated beets (beet powder), beetroot red/betanin (E162), ultramarine blue, caramel color (E150a), canthaxanthin (E161g), cryptoxanthin (E161c), rubixanthin (E161d), violanxanthin (E161e), rhodoxanthin (E161), caramel (E150(a-d)), β-apo-8′-carotenal (E60e), β-carotene (E60a), alpha carotene, gamma carotene, ethyl ester of beta-apo-8 carotenal (E160 ), flavoxanthin (E161a), lutein (E161b), cochineal extract (E120); carmine (E132), carmoisine/azorubine (E 122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), and combinations thereof.

Exemplary certified colors include FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminum (E173), silver (E174), gold (E175), pigment rubine/lithol rubine BK (E180), calcium carbonate (E170), carbon black (E153), black PN/brilliant black BN (E151), green S/acid brilliant green BS (E142), and combinations thereof. In some embodiments, certified colors can include FD&C aluminum lakes. These consist of the aluminum salts of FD&C dyes extended on an insoluble substrate of alumina hydrate. Additionally, in some embodiments, certified colors can be included as calcium salts. Preferred coloring agents include water-soluble coloring agents.

Suitable amounts of colorant to provide the desired visual effect can be selected by one of ordinary skill in the art without undue experimentation using guidelines provided. Exemplary amounts of coloring agents can be about 0.005 to about 15 weight percent, specifically about 0.01 to about 6 weight percent, and more specifically about 0.1 to about 2 weight percent, based on the total weight of the ready-to-drink beverage.

Emulsifiers can be added to the ready-to-drink beverage to prevent separation of the composition components by keeping ingredients dispersed. Emulsifiers include molecules that have both a hydrophilic part and a hydrophobic part. Emulsifiers can operate at the interface between hydrophilic and hydrophobic materials of the beverage to prevent separation of the components of the composition. Suitable emulsifiers for use in the compositions include, for example, lecithin (e.g., soy lecithin); monoglycerides and diglycerides of long chain fatty acids, specifically saturated fatty acids, and more specifically, stearic and palmitic acid mono- and diglycerides; monoglycerides and diglycerides of acetic acid, citric acid, tartaric acid, or lactic acid; polysorbates (e.g., polysorbate 20, polysorbate 40, polysorbate 60, polysorbate 65, and polysorbate 80), propylene glycol esters (e.g., propylene glycol monostearate); propylene glycol esters of fatty acids; sorbitan esters (e.g., sorbitan monostearates, sorbitan tristearates, sorbitan monolaurate, sorbitan monooleate), Acacia (gum arabic), sucrose monoesters; polyglycerol esters; polyethoxylated glycerols; and the like, and combinations thereof. The composition can contain the emulsifier in an amount of about 0.01 to about 2.0 weight percent, specifically about 0.05 to about 1.0 weight percent, more specifically about 0.075 to about 0.75 weight percent, and yet more specifically about 0.10 to about 0.50 weight percent, based on the total weight of the ready-to-drink beverage.

The ready-to-drink beverage can include certain components (sometimes referred to as hydrocolloids) that act as thickening agents and can impart added “mouth-feel” to the ready-to-drink beverage. Such components include natural and synthetic gums, for example locust bean gum, guar gum, gellan gum, xanthan gum, gum ghatti, modified gum ghatti, tragacanth gum, carrageenan, and the like; natural and modified starches, for example pregelatinized starch (corn, wheat, tapioca), pregelatinized high amylose-content starch, pregelatinized hydrolyzed starches (maltodextrins, corn syrup solids), chemically modified starches such as pregelatinized substituted starches (e.g., octenyl succinate), and the like; cellulose derivatives, for example carboxymethylcellulose, sodium carboxymethylcellulose, and the like; polydextrose; whey or whey protein concentrate; pectin; gelatin; and combinations thereof.

Preservatives, including antimicrobials, can be added to the composition to provide freshness and to prevent the unwanted growth of bacteria, molds, fungi, or yeast. The addition of a preservative, including antioxidants, may also be used to maintain the composition's color, flavor, or texture. Any suitable preservatives for use in food and beverage products can be incorporated into the compositions. Examples of suitable preservatives include benzoic acid alkali metal salts (e.g., sodium benzoate), sorbic acid alkali metal salts (e.g., potassium sorbate), ascorbic acid (Vitamin C), citric acid, calcium propionate, sodium erythorbate, sodium nitrite, sodium hexametaphosphate, calcium sorbate, butylated hydroxyanisole (BHA), butylated hydroxytoluene (BHT), ethylenediaminetetraacetic acid (EDTA), tocopherols (Vitamin E), straight chain polyphosphates, and combinations thereof. When present, the preservative can be used in an amount of about 0.01 to about 0.50 weight percent, specifically about 0.02 to about 0.30 weight percent, more specifically about 0.03 to about 0.10 weight percent, and yet more specifically about 0.05 to about 0.08 weight percent, based on the total weight of the ready-to-drink beverage.

The ready-to-drink beverage can be fortified or enriched with vitamins, minerals, micronutrients, or other nutrients. Micronutrients can include materials that have an impact on the nutritional well being of an organism even though the quantity required by the organism to have the desired effect is small relative to macronutrients, such as protein, carbohydrate, and fat. Micronutrients can include, for example, vitamins, minerals, enzymes, phytochemicals, antioxidants, and combinations thereof.

Suitable vitamins or vitamin precursors include ascorbic acid (Vitamin C), beta carotene, niacin (Vitamin B₃), riboflavin (Vitamin B₂), thiamin (Vitamin B₁), niacinamide, folate or folic acid, alpha tocopherols or esters thereof, Vitamin D, retinyl acetate, retinyl palmitate, pyridoxine (Vitamin B₆), folic acid (Vitamin B₉), cyanocobalimin (Vitamin B₁₂), pantothenic acid, biotin, and combinations thereof.

In some embodiments, vitamins or vitamin precursors can include fat soluble vitamins such as vitamin A, vitamin D, vitamin E, and vitamin K, and combinations thereof. In some embodiments, vitamins or vitamin precursors can include water soluble vitamins such as vitamin C (ascorbic acid), the B vitamins (thiamine or B₁, riboflavin or B₂, niacin or B₃, pyridoxine or B₆, folic acid or B₉, cyanocobalimin or B₁₂, pantothenic acid, biotin), and combinations thereof.

Exemplary minerals include sodium, magnesium, chromium, iodine, iron, manganese, calcium, copper, fluoride, potassium, phosphorous, molybdenum, selenium, zinc, and combinations thereof. The minerals can be provided as a mineral salt, including carbonate, oxide, hydroxide, chloride, sulfate, phosphate, pyrophosphate, gluconate, lactate, acetate, fumarate, citrate, malate, amino acids, and the like for the cationic minerals and sodium, potassium, calcium, magnesium and the like for the anionic minerals.

The amount of vitamins or minerals provided in the compositions can be up to or exceeding amounts generally recognized as U.S. Recommended Daily amounts or the Recommended Daily Intake amounts established by the U.S. Food and Drug Administration.

Antioxidants include materials that scavenge free radicals. Exemplary antioxidants can citric acid, rosemary oil, vitamin A, vitamin E, vitamin E phosphate, tocopherols, di-alpha-tocopheryl phosphate, tocotrienols, alpha lipoic acid, dihydrolipoic acid, xanthophylls, beta cryptoxanthin, lycopene, lutein, zeaxanthin, astaxanthin, beta-carotene, carotenes, mixed carotenoids, polyphenols, flavonoids, and combinations thereof.

Phytochemicals (“phytonutrients”) are plant-derived compounds that may provide a beneficial effect on the health or well being of the consumer. Phytochemicals include plant-derived antioxidants, phenolic compounds including monophenols and polyphenols, and the like. Exemplary phytochemicals include lutein, lycopene, carotene, anthocyanin, capsaicinoids, flavonoids, hydroxycinnarnic acids, isoflavones, isothiocyanates, monoterpenes, chalcones, coumestans, dihydroflavonols, flavanoids, flavanols, quercetin, flavanones, flavones, flavan-3-ols (catechins, epicatechin, epigallocatechin, epigallocatechingallate, and the like), flavonals (anthocyanins, cyanidine, and the like); phenolic acids; phytosterols, saponins, terpenes (carotenoids), and combinations thereof.

The phytochemicals can be provided in substantially pure or isolated form or in the form of natural plant extracts. Suitable plant extracts which contain one or more phytochemicals include fruit skin extracts (grape, apple, crab apple, and the like), green tea extracts, white tea extracts, green coffee extract, and combinations thereof.

Various herbals, aromatic plants or plant parts or extracts thereof, can also be included in the compositions for a variety of reasons such as for flavor or for their potential health benefits. Exemplary herbals include Echinacea, Goldenseal, Calendula, Rosemary, Thyme, Kava Kava, Aloe, Blood Root, Grapefruit Seed Extract, Black Cohosh, Ginseng, Guarana, Cranberry, Ginko Biloba, St. John's Wort, Evening Primrose Oil, Yohimbe Bark, Green Tea, Ma Huang, Maca, Bilberry, extracts thereof, and combinations thereof.

The ready-to-drink beverage can further include a dissolved gas. Suitable dissolved gases include carbon dioxide, nitrogen, oxygen, nitrous oxide, and combinations thereof. When present, the dissolved gas can be used in an amount of contain about 0.1 to about 5.0 volumes of gas per volume of the ready-to-drink beverage, specifically about 1.0 to about 4.5 volumes, and more specifically about 2.0 to about 3.5 volumes. The gas can be provided in the beverage by forceful introduction of the gas under pressure to the ready-to-drink beverage. Cooling the ready-to-drink beverage allows for greater amounts of gas to be solubilized.

In a very specific embodiment of a sweetened ready-to-drink beverage, the beverage comprises about 35 to about 65 weight percent of the malt-based alcoholic composition; the beverage comprises the malt-based alcoholic composition in an amount effective to provide an alcohol content of about 6 to about 8 percent by volume, based on the total volume of the ready-to-drink beverage; the beverage further comprises about 18 to about 24 weight percent high fructose corn syrup; the beverage further comprises about 0.3 to about 0.8 weight percent citric acid; wherein all weight percents are based on the total weight of the ready-to-drink beverage; and wherein the malt-based alcoholic composition has a Hop Aroma Component Profile value less than or equal to 0.03 microliter per liter.

In some embodiments, the ready-to-drink beverage comprises a tomato component in an amount effective to provide a natural tomato soluble solids content of about 3.5 to about 5.5 percent by weight, based on the total weight of the ready-to-drink beverage, and the ready-to-drink beverage comprises less than or equal to 0.2 volumes of dissolved gas per volume of the ready-to-drink beverage. These embodiments are collectively referred to as the tomato-component-containing ready-to-drink beverages.

The tomato component can be a tomato concentrate such as tomato puree or tomato paste. Tomato pastes typically have a natural tomato soluble solids content of at least about 24% by weight, more specifically, about 24 to about 36% by weight. Tomato purees typically have a natural tomato soluble solids content of about 8 to about 24% by weight. Natural tomato soluble solids (sometimes referred to herein as “NTSS” or “tomato solids”) can be determined using a refractometer as described in AOAC method 970.59.

In some embodiments, the tomato component has a natural tomato soluble solids content of about 20 to about 40 percent by weight, specifically about 25 to about 35 weight percent, based on the weight of the tomato component.

The ready-to-drink beverage comprises a tomato component in an amount effective to provide a natural tomato soluble solids content of about 3.5 to about 5.5 percent by weight, specifically about 4 to about 5 percent by weight, based on the total weight of the ready-to-drink beverage.

In some embodiments, the tomato-component-containing ready-to-drink beverage comprises about 20 to about 60 volume percent insoluble solids. Within this range, the insoluble solids can be about 30 to about 50 volume percent, specifically about 35 to about 45 volume percent. Insoluble solids are typically determined by a centrifugation technique that separates the insoluble solids from the beverage. The insoluble solids value is expressed as a volume percent and determined by separating the solids via centrifuge and measuring the volume percent solids in the centrifuge tube.

The tomato-component-containing ready-to-drink beverage comprises less than or equal to 0.2 volumes of dissolved gas per volume of the ready-to-drink beverage, specifically less than or equal to 0.1 volumes of dissolved gas per volume of the ready-to-drink beverage. This means, for example, that the beverage is distinguished from carbonated beverages.

In addition to the tomato component and the malt-based alcoholic composition, the tomato-component-containing ready-to-drink beverage can, optionally, comprise one or more of the flavors described above. Particularly preferred flavors include spicy flavors, such as red pepper, black pepper, horseradish, wasabi, jalapeno pepper, chipotle pepper, extracts or purees of the foregoing, and combinations thereof.

Another optional flavoring particularly suitable for the tomato-component-containing ready-to-drink beverage is vinegar. The term “vinegar” refers to a sour-tasting liquid containing acetic acid, obtained by fermenting dilute alcoholic liquids. Suitable vinegars include white vinegar, apple cider vinegar, red wine vinegar, white wine vinegar, and the like, and combinations thereof. Although vinegar has sometimes been used as an ingredient in Bloody Mary mixes, the present inventor has determined that a higher-than-usual concentration of vinegar can be beneficial in these malt-based beverages compared to the corresponding vodka-based beverages. Without wishing to be bound by any particular theory, the present inventor speculates that the higher concentration of vinegar may be beneficial because it complements the sweeter taste of the malt-based alcoholic composition when compared to vodka. When present, the vinegar can be used in an amount effective to provide an acetic acid concentration of about 0.05 to about 0.11 weight percent acetic acid, specifically about 0.07 to about 0.09 weight percent, based on the total weight of the ready-to-drink beverage.

Other flavors particularly suitable for the tomato-component-containing ready-to-drink beverage are savory flavors and citrus flavors. Savory flavors can include those that impart meaty, fried, fatty, roasted, allium, smoky, and cheesy notes. More specifically, savory flavors can include, but are not limited to, onion flavor, garlic flavor, celery seed, anchovy flavor, ginseng, taurine, guarana, Worcestershire flavor, soy sauce flavor, yeast extract flavor, beef flavor, dill, carrot, parsley, beet, lettuce, watercress, arugula, spinach, other seafood flavors, and combinations thereof. Savory vegetable flavors such as those associated with carrots, celery, beets, parsley, lettuce, watercress, and spinach, can be provided as part of the tomato component when the tomato component is a multi-vegetable juice comprising tomato juice and juices or extracts from one or more of the foregoing vegetables. Citrus flavors include lemon, lime, orange, grapefruit, tangerine, and the like, and combinations thereof.

In some embodiments, the tomato-component-containing ready-to-drink beverage further comprises citric acid in an amount of about 0.02 to about 0.05 weight percent, based on the total weight of the ready-to-drink beverage.

The tomato-component-containing ready-to-drink beverage is typically mildly acidic. For example, in some embodiments, it has a pH of 3.5 to 4.1, specifically 3.6 to 4.0, as measured at 20° C.

The tomato-component-containing ready-to-drink beverage can, optionally, further include a sweetener. However, the present inventor has determined that the tomato component and malt-based alcoholic composition contribute a desirable and distinctively mild sweetness to ready-to-drink beverage even when no added sweetener is used. Thus, in some embodiments, the tomato-component-containing ready-to-drink beverage is substantially free of sweeteners other than those present in the tomato component and the malt-based alcoholic composition. In this context, the term “substantially free” does not exclude the small amounts of naturally occurring sweeteners contributed by optional plant-based components such as chili peppers, lemons, limes, juices and extracts of the foregoing, and the like. In some embodiments, the method of preparing the tomato-component-containing ready-to-drink beverage excludes the addition of sweeteners per se (including the sweeteners listed above).

In a very specific embodiment of the tomato-component-containing ready-to-drink beverage, the tomato component is present in an amount effective to provide a natural tomato soluble solids content of about 4 to about 5 percent by weight, based on the total weight of the ready-to-drink beverage; the tomato component has a natural tomato soluble solids content of about 25 to about 35 percent by weight, based on the weight of the tomato component; the ready-to-drink beverage comprises about 30 to about 50 volume percent insoluble solids; the malt-based alcoholic composition has a Hop Aroma Component Profile value less than or equal to 0.03 microliter per liter; the ready-to-drink beverage comprises less than or equal to 0.1 volume of dissolved gas per volume of the ready-to-drink beverage; the ready-to-drink beverage further comprises a spicy flavor selected from the group consisting of red pepper, black pepper, horseradish, wasabi, jalapeno pepper, chipotle pepper, extracts or purees of the foregoing, and combinations thereof, the ready-to-drink beverage further comprises vinegar in an amount effective to provide an acetic acid concentration of about 0.05 to about 0.11 weight percent acetic acid, based on the total weight of the ready-to-drink beverage; the ready-to-drink beverage further comprises about 0.02 to about 0.05 weight percent citric acid, based on the total weight of the ready-to-drink beverage; the ready-to-drink beverage is packaged in a can; and the ready-to-drink beverage is in-can pasteurized.

In some embodiments, the ready-to-drink beverage is subjected to homogenization conditions, such as high pressure homogenization, to provide a homogenous composition. A beverage component used to prepare the ready-to-drink beverage can be homogenized alone, or alternatively, the beverage as a whole can be homogenized. High pressure homogenization can be used. In general, homogenization processes alter the size and distribution of fruit or vegetable pulp particles. More specifically, homogenization may break down and uniformly distribute the lipophilic components, the fruit or vegetable pulp particles, etc. throughout the composition. In addition, homogenization may modify the fruit or vegetable fibers found in the composition by reducing the length and fraying the ends of the fibrous materials. This may allow the fiber strands to absorb more liquid. Overall, homogenization may produce a more uniform composition having increased viscosity. In some embodiments, a homogenization pressure of about 1000 pounds per square inch (6,895 kilopascals) to about 4000 pounds per square inch (27,579 kilopascals) is used. Any conventional homogenization equipment can be employed, such as equipment available from APV Gaulin, Alfa-Laval or Niro Soavi.

The ready-to-drink beverage can be pasteurized to further enhance shelf life. Although tomato products and beer typically are pasteurized at different temperatures, the ready-to-drink beverage containing both of these components can be pasteurized after they are combined. Pasteurization temperatures are typically about 60 to about 90° C., specifically about 70 to about 80° C. More specifically, the beverage composition can be pasteurized by heating the composition to about 60 to about 90° C. for about 6 to about 15 minutes in an aseptic environment. In some embodiments, the beverage composition is be filled into the desired beverage container, such as a can, a glass bottle, or a plastic bottle, and then subjected to the pasteurization conditions to yield an in-can pasteurized product. It will be understood that the word “can” in the term “in-can pasteurized product” refers to any suitable beverage container, including a can, a glass bottle, or a plastic bottle. In other embodiments, the beverage container is “hot filled” by pasteurizing the beverage composition and filling the beverage container with the still-hot pasteurized beverage composition. The use of hot filling may be particularly preferred when the beverage container is a plastic bottle.

The invention includes methods of preparing the ready-to-drink beverage. Thus, one embodiment is a method of preparing a ready-to-drink beverage, comprising: blending a tomato component and a malt-based alcoholic composition to produce a ready-to-drink beverage; wherein the ready-to-drink beverage has a natural tomato soluble solids content of about 3.5 to about 5.5 percent by weight, based on the total weight of the ready-to-drink beverage; wherein the ready-to-drink beverage has an alcohol content of about 5 to about 9 percent by volume, based on the total volume of the ready-to-drink beverage; wherein the malt-based alcoholic composition is substantially free of hops flavor; and wherein the ready-to-drink beverage comprises less than or equal to 0.2 volumes of dissolved gas per volume of the ready-to-drink beverage.

All of the embodiments described above in the context of the ready-to-drink beverage itself are equally applicable to the method of preparing the ready-to-drink beverage.

In a very specific embodiment of the method of preparing the ready-to-drink beverage, the tomato component is present in an amount effective to provide a natural tomato soluble solids content of about 4 to about 5 percent by weight, based on the total weight of the ready-to-drink beverage; the tomato component has a natural tomato soluble solids content of about 25 to about 35 percent by weight, based on the weight of the tomato component; the ready-to-drink beverage comprises about 30 to about 50 volume percent insoluble solids; the malt-based alcoholic composition has a Hop Aroma Component Profile value less than or equal to 0.03 microliter per liter; the ready-to-drink beverage comprises less than or equal to 0.1 volume of dissolved gas per volume of the ready-to-drink beverage; the ready-to-drink beverage further comprises a spicy flavor selected from the group consisting of red pepper, black pepper, horseradish, wasabi, jalapeno pepper, chipotle pepper, extracts or purees of the foregoing, and combinations thereof, the ready-to-drink beverage further comprises vinegar in an amount effective to provide an acetic acid concentration of about 0.05 to about 0.11 weight percent acetic acid, based on the total weight of the ready-to-drink beverage; the ready-to-drink beverage further comprises about 0.02 to about 0.05 weight percent citric acid, based on the total weight of the ready-to-drink beverage; the method further comprises packaging the ready-to-drink beverage in a can; and the method further comprises pasteurizing the ready-to-drink beverage in the can.

The invention is further illustrated by the following non-limiting examples.

### EXAMPLE 1

This example illustrates the preparation of a ready-to-drink beverage.

A neutral-flavored malt beverage have no detectable hops flavor and an alcohol content of 14 volume percent is prepared according to methods known in the art. See, for example, U.S. Pat. No. 7,008,652 B2 to Effler, herein incorporated by reference.

A beverage concentrate is prepared by combining the components and amounts specified in Table 1. The finished concentrate has a brix value of 11.5±0.5 brix as measured by refractometer at 20° C., a pH of 3.6±0.2 at 20° C., and a natural tomato soluble solids value of 9.0±0.2 weight percent.

TABLE 1

| Component | Parts by Weight |
|---|---|
| Water | 65.6625 |
| Preservatives | 0.1368 |
| Tomato paste, cold break, 31 NTSS | 29.0861 |
| Sodium chloride | 1.5969 |
| Citric acid, anhydrous | 0.6273 |
| Vinegar, white, 100 grain | 1.6585 |
| Chili pepper puree | 0.3080 |
| Spice blend | 0.3080 |
| Worcestershire sauce, 4× strength | 0.5133 |
| Pepper sauce | 0.0456 |
| Ascorbic acid | 0.0570 |

A ready-to-drink beverage is prepared by mixing equal volumes of the neutral-flavored malt beverage and the beverage concentrate at 20° C. The ready-to-drink beverage has an alcohol content of 7 volume percent at 20° C., a pH of 3.8±0.2 at 20° C., a natural tomato soluble solids value of 5.2±0.2 weight percent, and an insoluble solids content of 42 volume percent.

### EXAMPLE 2

This example illustrates the preparation of a malt-based, ready-to-drink beverage composition having the flavor characteristics of a gin and tonic cocktail. The components in Table 2 were blended to form a solution having a pH of 2.5 to 3, which was then carbonated with 3±0.5 volumes carbon dioxide and bottled.

TABLE 2

| Component | Parts by Weight |
|---|---|
| Neutral-flavored malt beverage, | 50.00 |
| 14% alcohol by volume | |
| Water | 27.84 |
| High fructose corn syrup | 21.00 |
| Citric acid, anhydrous | 0.67 |
| Sodium citrate | 0.07 |
| Gin flavor | 0.13 |
| Tonic flavor | 0.08 |
| Lime flavor | 0.14 |
| Sodium benzoate | 0-0.05 |
| Potassium sorbate | 0-0.02 |

### EXAMPLE 3

This example illustrates the preparation of a malt-based, ready-to-drink beverage composition having the flavor characteristics of a rye and ginger cocktail. The components in Table 3 were blended to form a solution having a pH of 3 to 3.5, which was then carbonated with 3±0.5 volumes carbon dioxide and bottled.

TABLE 3

| Component | Parts by Weight |
|---|---|
| Neutral-flavored malt beverage, | 50.00 |
| 14% alcohol by volume | |
| Water | 28.09 |
| High fructose corn syrup | 21.00 |
| Citric acid, anhydrous | 0.46 |
| Sodium citrate | 0.05 |
| Rye (whiskey) flavor | 0.09 |
| Ginger ale flavor | 0.21 |
| Sodium benzoate | 0-0.05 |
| Potassium sorbate | 0-0.02 |
| Caramel color, 2X | 0.03 |

### EXAMPLE 4

This example illustrates the preparation of a malt-based, ready-to-drink beverage composition having the flavor characteristics of a vodka and lemon cocktail. The components in Table 4 were blended to form a solution having a pH of 2.5 to 3, which was then carbonated with 3±0.5 volumes carbon dioxide and bottled.

TABLE 4

| Component | Parts by Weight |
|---|---|
| Neutral-flavored malt beverage, | 50.00 |
| 14% alcohol by volume | |
| Water | 27.86 |
| High fructose corn syrup | 21.00 |
| Citric acid, anhydrous | 0.7 |
| Sodium citrate | 0.07 |
| Lemon flavor | 0.18 |
| Lime flavor | 0.08 |
| Top note flavor | 0.04 |
| Sodium benzoate | 0-0.05 |
| Potassium sorbate | 0-0.02 |

### EXAMPLE 5

This example illustrates the preparation of a malt-based, ready-to-drink beverage composition having the flavor characteristics of a vodka and reduced calorie lemon cocktail. The components in Table 5 were blended to form a solution having a pH of 2.5 to 3, which was then carbonated with 3±0.5 volumes carbon dioxide and bottled.

TABLE 5

| Component | Parts by Weight |
|---|---|
| Neutral-flavored malt beverage, | 50.00 |
| 14% alcohol by volume | |
| Water | 36.08 |
| High fructose corn syrup | 13.00 |
| Citric acid, anhydrous | 0.50 |
| Sodium citrate | 0.05 |
| Lemon flavor | 0.18 |
| Lime flavor | 0.08 |
| Top note flavor | 0.04 |
| Sodium benzoate | 0-0.05 |
| Potassium sorbate | 0-0.02 |

### EXAMPLE 6

This example illustrates the preparation of a malt-based, ready-to-drink beverage composition having the flavor characteristics of a vodka and diet lemon cocktail. The components in Table 6 were blended to form a solution having a pH of 2.5 to 3, which was then carbonated with 3±0.5 volumes carbon dioxide and bottled.

TABLE 6

| Component | Parts by Weight |
|---|---|
| Neutral-flavored malt beverage, | 50.00 |
| 14% alcohol by volume | |
| Water | 48.92 |
| Sucralose solution, 25% w/w | 0.10 |
| AceK sulfame | 0.02 |
| Citric acid, anhydrous | 0.40 |
| Sodium citrate | 0.04 |
| Lemon flavor | 0.25 |
| Lime flavor | 0.12 |
| Tom note flavor | 0.08 |
| Sodium benzoate | 0-0.05 |
| Potassium sorbate | 0-0.02 |

### EXAMPLE 7

This example illustrates the preparation of a malt-based, ready-to-drink beverage composition having the flavor characteristics of a mojito cocktail. The components in Table 7 were blended to form a solution having a pH of 2.5 to 3, which was then optionally carbonated with 2 to 3 volumes carbon dioxide and bottled.

TABLE 4

| Component | Parts by Weight |
|---|---|
| Neutral-flavored malt beverage, | 50.00 |
| 14% alcohol by volume | |
| Water | 27.85 |
| High fructose corn syrup | 21.00 |
| Citric acid, anhydrous | 0.65 |
| Sodium citrate | 0.07 |
| Lime flavor | 0.2 |
| Mint flavor | 0.15 |
| Tropical flavor | 0.1 |
| Sodium benzoate | 0-0.05 |
| Potassium sorbate | 0-0.02 |
| Sodium metabisulfite | 0-0.001 |
| Color FD&C | 0.001 |
| Cloud emulation | 0.015 |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A ready-to-drink beverage, comprising:
a malt-based alcoholic composition in an amount effective to provide an alcohol content of about 5 to about 9 percent by volume, based on the total volume of the ready-to-drink beverage;
wherein malt-based alcoholic composition has a Hop Aroma Component Profile value less than or equal to 0.05 microliter per liter; and
wherein at least 90% of the alcohol content of the ready-to-drink beverage is derived from the malt-based alcoholic composition.

2. The ready-to-drink beverage of claim 1, wherein at least 95% of the alcohol content of the ready-to-drink beverage is derived from the malt-based alcoholic composition.

3. The ready-to-drink beverage of claim 1, wherein the malt-based alcoholic composition has an alcohol content of about 12 to about 15 percent by volume.

4. The ready-to-drink beverage of claim 1, comprising about 35 to about 65 weight percent of the malt-based alcoholic composition, based on the total weight of the ready-to-drink beverage.

5. The ready-to-drink beverage of claim 1, comprising less than or equal to 0.9 weight percent citric acid, based on the total weight of the ready-to-drink beverage.

6. The ready-to-drink beverage of claim 1, further comprising a bulk sweetener selected from the group consisting of sucrose, dextrose, maltose, dextrin, xylose, ribose, glucose, mannose, galactose, fructose, lactose, invert sugar, fructooligosaccharide syrups, partially hydrolyzed starch, corn syrup solids, high fructose corn syrup, sorbitol, xylitol, mannitol, galactitol, maltitol, hydrogenated isomaltulose, lactitol, erythritol, hydrogenated starch hydrolysates, and combinations thereof; wherein the weight percent is based on the total weight of the ready-to-drink beverage.

7. The ready-to-drink beverage of claim 6, comprising about 10 to about 25 weight percent of the bulk sweetener.

8. The ready-to-drink beverage of claim 1, further comprising a high-intensity sweetener selected from the group consisting of saccharin, saccharin salts, cyclamate salts, sodium and potassium and ammonium and calcium salts of 3,4-dihydro-6-methyl-1,2,3-oxathiazine-4-one-2,2-dioxide, L-aspartyl-L-phenylalanine methyl ester, L-alpha-aspartyl-N-(2,2,4,4-tetramethyl-3-thietanyl)-D-alaninamide hydrate, N-[N-(3,3-dimethylbutyl)-L-aspartyl]-L-phenylalanine 1-methyl ester, methyl esters of L-aspartyl-L-phenylglycerine and L-aspartyl-L-2,5-dihydrophenyl-glycine, L-aspartyl-2,5-dihydro-L-phenylalanine, L-aspartyl-L-(1-cyclohexen)-alanine, 1-chloro-1′-deoxysucrose, 4-chloro-4-deoxy-alpha-D-galactopyranosyl-alpha-D-fructofuranoside, 4-chloro-4-deoxygalactosucrose, 4-chloro-4-deoxy-alpha-D-galactopyranosyl-1-chloro-1-deoxy-beta-D-fructo-furanoside, 4,1′-dichloro-4,1′-dideoxygalactosucrose, 1′,6′-dichloro 1′,6′-dideoxysucrose, 4-chloro-4-deoxy-alpha-D-galactopyranosyl-1,6-dichloro-1,6-dideoxy-beta-D-fructofuranoside, 4,1′,6′-trichloro-4,1′,6′-trideoxygalactosucrose, 4,6-dichloro-4,6-dideoxy-alpha-D-galactopyranosyl-6-chloro-6-deoxy-beta-D-fructofuranoside, 4,6,6′-trichloro-4,6,6′-trideoxygalactosucrose, 6,1′,6′-trichloro-6,1′,6′-trideoxysucrose, 4,6-dichloro-4,6-dideoxy-alpha-D-galacto-pyranosyl-1,6-dichloro-1,6-dideoxy-beta-D-fructofuranoside, 4,6,1′,6′-tetrachloro4,6,1′,6′-tetradeoxygalacto-sucrose, 4,6,1′,6′-tetradeoxy-sucrose, thaumaoccous danielli (Thaumatin I and II), rebaudiosides, monatin, lo han quo, and combinations thereof.

9. The ready-to-drink beverage of claim 1,
comprising about 35 to about 65 weight percent of the malt-based alcoholic composition,
comprising the malt-based alcoholic composition in an amount effective to provide an alcohol content of about 6 to about 8 percent by volume, based on the total volume of the ready-to-drink beverage;
further comprising about 18 to about 24 weight percent high fructose corn syrup;
further comprising about 0.3 to about 0.8 weight percent citric acid;
wherein all weight percents are based on the total weight of the ready-to-drink beverage; and
wherein the malt-based alcoholic composition has a Hop Aroma Component Profile value less than or equal to 0.03 microliter per liter.

10. The ready-to-drink beverage of claim 1,
wherein the ready-to-drink beverage is packaged in a can; and
wherein the ready-to-drink beverage is in-can pasteurized.

11. The ready-to-drink beverage,
further comprising a tomato component in an amount effective to provide a natural tomato soluble solids content of about 3.5 to about 5.5 percent by weight, based on the total weight of the ready-to-drink beverage;
wherein the ready-to-drink beverage comprises less than or equal to 0.2 volumes of dissolved gas per volume of the ready-to-drink beverage.

12. The ready-to-drink beverage of claim 11, comprising about 20 to about 60 volume percent insoluble solids.

13. The ready-to-drink beverage of claim 11, wherein the tomato component has a natural tomato soluble solids content of about 20 to about 40 percent by weight, based on the weight of the tomato component.

14. The ready-to-drink beverage of claim 11, further comprising a spicy flavor selected from the group consisting of red pepper, black pepper, horseradish, wasabi, jalapeno pepper, chipotle pepper, extracts or purees of the foregoing, and combinations thereof.

15. The ready-to-drink beverage of claim 11, further comprising vinegar.

16. The ready-to-drink beverage of claim 11, further comprising about 0.02 to about 0.05 weight percent citric acid, based on the total weight of the ready-to-drink beverage.

17. The ready-to-drink beverage of claim 11, having a pH of about 3.4 to about 4.1 as measured at 20° C.

18. The ready-to-drink beverage of claim 11, wherein the ready-to-drink beverage is substantially free of sweeteners other than those present in the tomato component and the malt-based alcoholic composition.

19. The ready-to-drink beverage of claim 11,
wherein the tomato component is present in an amount effective to provide a natural tomato soluble solids content of about 4 to about 5 percent by weight, based on the total weight of the ready-to-drink beverage;
wherein the tomato component has a natural tomato soluble solids content of about 25 to about 35 percent by weight, based on the weight of the tomato component;
wherein the ready-to-drink beverage comprises about 30 to about 50 volume percent insoluble solids;
wherein the malt-based alcoholic composition has a Hop Aroma Component Profile value less than or equal to 0.03 microliter per liter;
wherein the ready-to-drink beverage comprises less than or equal to 0.1 volume of dissolved gas per volume of the ready-to-drink beverage;
wherein the ready-to-drink beverage further comprises a spicy flavor selected from the group consisting of red pepper, black pepper, horseradish, wasabi, jalapeno pepper, chipotle pepper, extracts or purees of the foregoing, and combinations thereof,
wherein the ready-to-drink beverage further comprises vinegar in an amount effective to provide an acetic acid concentration of about 0.05 to about 0.11 weight percent acetic acid, based on the total weight of the ready-to-drink beverage;
wherein the ready-to-drink beverage further comprises about 0.02 to about 0.05 weight percent citric acid, based on the total weight of the ready-to-drink beverage;
wherein the ready-to-drink beverage is packaged in a can; and
wherein the ready-to-drink beverage is in-can pasteurized.
